(19) United States
(12) Patent Application Publication
(10) Pub. No.: US 2026/0329474 A1
(43) Pub. Date: Oct. 22, 2026

(54) TECHNIQUE TO REDUCE MEMORY FOOTPRINT AND IMPROVE PERFORMANCE FOR MAPPING CACHES

(71) Applicant: Dell Products L.P., Round Rock, TX (US)

(72) Inventors: Ashok Tamilarasan, Shrewsbury, MA (US); Vamsi K. Vankamamidi, Hopkinton, MA (US); Alexander Shknevsky, Fair Lawn, NJ (US); Ajay Karri, South Grafton, MA (US); John Harvey, Wrentham, MA (US)

(21) Appl. No.: 19/180,326

(22) Filed: Apr. 16, 2025

(51) Int. Cl. G06F 3/06

(52) U.S. Cl. CPC G06F 3/0656; G06F 3/0608; G06F 3/0676; G06F 3/0679

(57) ABSTRACT

Techniques for reducing memory footprints and improving performance of mapping caches. The techniques include receiving a read request for reading a dataset associated with a volume LBA. The techniques include, in response to a mapping cache hit based on a hash of the volume LBA, obtaining, from a PD including the volume LBA, a PLB address and a first generation number for a dataset originally (or previously) stored at the PLB address. The techniques include obtaining a second generation number from a PLB header associated with a dataset currently stored at the PLB address, and determining that the second generation number matches the first generation number. The techniques include determining that a hash value calculated for the dataset currently stored at the PLB address matches a hash value maintained in the PLB header, reading the dataset currently stored at the PLB address, and returning the dataset to a client.

### BACKGROUND

Storage systems include storage processors coupled to arrays of storage drives, such as solid state drives (SSDs) and hard disk drives (HDDs). The storage processors receive and service storage input/output (IO) requests (e.g., write requests, read requests) issued by client computers (“clients”), which transmit the write requests and read requests to the storage systems over one or more networks. The write requests and read requests specify data pages, data blocks, data files, or other data elements to be written to or read from volumes (VOLs), logical units (LUs), filesystems, or other storage objects maintained on the storage drives. The storage systems implement a multi-layered storage stack including a namespace layer, a mapping layer, a virtualization layer, and a physical layer. The namespace layer consumes a logical address space of the mapping layer, and tracks logical addresses (e.g., logical block addresses (LBAs)) of the storage objects (e.g., VOLs). The mapping layer maps the LBAs of the VOLs (“volume LBAs”) to virtual addresses, which are maintained in virtual large blocks (VLBs) in the virtualization layer. The physical layer includes an aggregation of physical large blocks (PLBs), each of which can include one or more compressed (or uncompressed) datasets (e.g., one or more data pages). Each virtual address maintained in a VLB (“VLB address”) points to a physical address of a dataset in a PLB (“PLB address”), with actual physical storage of the dataset being provided on an underlying storage drive in a backend of the storage system.

### SUMMARY

Upon receipt of a write request from a client for writing one or more data pages, a storage system performs a write operation, which can include (i) calculating hash values uniquely identifying the respective data pages, (ii) performing a data reduction process (e.g., data compression) on the data pages to obtain a compressed dataset, (iii) mapping, from the namespace layer to the physical layer, a volume LBA associated with the compressed dataset to a VLB address that points to a PLB address, (iv) maintaining, in the VLB, the hash values for the respective data pages, and (iv) storing the compressed dataset at the PLB address.

Upon receipt of a read request from the client for reading one or more of the data pages in the compressed dataset, the storage system performs a read operation, which can include (i) reading the compressed dataset at the PLB address, (ii) decompressing the compressed dataset to obtain the data pages, (iii) calculating hash value(s) based on the respective obtained data page(s) specified in the read request, (iv) performing a read validation process to assure that the hash value(s) for the respective obtained data page(s) match the previously calculated hash value(s) maintained in the VLB, and (v) if the read validation process is successful, returning the requested data page(s) to the client. However, such steps for performing write operations and read operations in a storage system can be expensive in terms of central processing unit (CPU) cycles and performance.

Moreover, in a storage system that implements log-structured data storage, changing, modifying, or replacing data at one or more volume LBAs can cause a corresponding compressed (or uncompressed) dataset to be stored or logged not at its initial PLB address, but at a different PLB address. To determine whether such a dataset has been stored or logged at a different PLB address, the storage system can calculate a hash value (e.g., 16 bytes) based on the original dataset, and store the hash value in an in-memory page descriptor (PD). The storage system can further calculate a second hash value based on data currently stored at the initial PLB address, and compare the second hash value with the previously calculated hash value stored in the PD. If the second hash value does not match the previously calculated hash value, then it can be concluded that the dataset has been changed, modified, or replaced, and stored or logged at the different PLB address. However, calculating hash values for datasets (e.g., one or more data pages) and storing them in in-memory PDs can be expensive, not only in terms of CPU cycles and performance, but also in terms of memory space and consumption.

Techniques are disclosed herein for reducing memory footprints and improving performance of mapping caches in storage systems. In the disclosed techniques, a storage system can implement a multi-layered storage stack that includes a namespace layer, a mapping layer, a virtualization layer, and a physical layer for mapping LBAs of storage objects (e.g., volume LBAs) to virtual addresses in VLBs (“VLB addresses”), which point to physical addresses of datasets (e.g., one or more data pages) in PLBs (“PLB addresses”). Actual physical storage of the datasets can be provided on one or more underlying storage drives in the backend. The storage system can include at least one mapping cache, which can provide direct mappings of volume LBAs to PLB addresses for recently accessed datasets, effectively bypassing at least the multi-layered storage stack. The storage system can maintain a header data structure (“PLB header”) for each compressed (or uncompressed) dataset, and store the PLB header with the dataset at a PLB address. For example, each compressed dataset may correspond to a deep compressed dataset, in which four (4) data pages, eight (8) data pages, or any other suitable number of data pages, are compressed together. Further, each data page may have a size of 4 kilobytes (Kb), 8 Kb, or any other suitable size. In one embodiment, a dataset that includes eight (8) 4 Kb data pages (i.e., 32 Kb of data) can be deep compressed to 12 Kb of data. The PLB header can include a generation number for the dataset stored at the PLB address, and a hash value, calculated for read validation purposes, for each data page included in the dataset. The storage system can also maintain an in-memory PD for the dataset stored at the PLB address. The PD can store a volume LBA and a generation number for the dataset at the PLB address, as well as an indication of the PLB address (e.g., PLB address/offset/length). The disclosed techniques are particularly suited for use in storage systems that implement log-structured data storage.

The disclosed techniques can include receiving a read request for reading at least a portion of a dataset including a plurality of data pages, in which the dataset is associated with a volume LBA. The disclosed techniques can include, in response to a mapping cache hit based on a hash of the volume LBA, obtaining, from a PD storing the volume LBA, a PLB address, and a first generation number for a compressed (or uncompressed) dataset originally (or previously) stored at the PLB address. The disclosed techniques can include obtaining a second generation number from a PLB header associated with a dataset currently stored at the PLB address. The disclosed techniques can include determining that the second generation number matches the first generation number, indicating that the dataset originally (or previously) stored at the PLB address corresponds to the dataset currently stored at the PLB address, and has not been changed, modified, or replaced, and moved, stored, or logged at a different PLB address. The disclosed techniques can include, having determined that the second generation number matches the first generation number, (i) reading the dataset currently stored at the PLB address, (ii) if the dataset is compressed, decompressing the dataset to obtain the plurality of data pages, (iii) calculating hash values for one or more data pages from among the plurality of data pages, as specified in the read request, (iv) determining that the hash values for the one or more data pages match corresponding hash values in the PLB header, and (v) in response to the hash values for the one or more data pages matching the corresponding hash values in the PLB header, returning the one or more data pages to the client. By employing, in a storage system, a mapping cache that can provide direct mappings of volume LBAs to PLB addresses for recently accessed datasets, an amount of CPU cycles required for reading datasets in physical storage can be reduced. In addition, by maintaining one or more hash values in PLB headers associated with the datasets in physical storage, memory space and consumption in the storage system can also be reduced.

In certain embodiments, a method includes receiving a read request for reading at least a portion of a dataset including a plurality of data pages. The dataset is associated with a logical storage address. The method includes, in response to a cache hit in a mapping cache based on a hash of the logical storage address, obtaining, from an in-memory page descriptor (PD) storing the logical storage address, a physical storage address, and a generation number for a dataset originally or previously stored at the physical storage address. The method includes obtaining a generation number from a header data structure associated with a dataset currently stored at the physical storage address, and determining that the generation number from the header data structure matches the generation number stored in the PD, indicating that the dataset originally or previously stored at the physical storage address corresponds to the dataset currently stored at the physical storage address. The method includes, having determined that the generation number from the header data structure matches the generation number stored in the PD, reading the dataset currently stored at the physical storage address, and returning, to the client, one or more data pages from among the plurality of data pages included in the dataset, as specified in the read request.

In certain arrangements, the method includes determining that the dataset is compressed, and decompressing the dataset to obtain the plurality of data pages.

In certain arrangements, the method includes calculating hash values for the one or more data pages, and determining, in a read validation process, whether the calculated hash values match corresponding hash values in the header data structure.

In certain arrangements, the method includes returning the one or more data pages to the client in response to the calculated hash values matching the corresponding hash values in the header data structure.

In certain arrangements, the method includes, in response to the calculated hash values not matching the corresponding hash values in the header data structure, performing cache miss processing including removing a hash line corresponding to the cache hit from the mapping cache, and returning the PD to a pool of PDs to make the PD available for reuse.

In certain arrangements, the method includes receiving a second read request for reading at least a portion of a second dataset including a second plurality of data pages. The second dataset is associated with a second logical storage address. The method includes, in response to a cache hit in the mapping cache based on a hash of the second logical storage address, obtaining, from an in-memory PD storing the second logical storage address, a second physical storage address, and a generation number for a dataset originally or previously stored at the second physical storage address. The method includes obtaining a generation number from a header data structure associated with a dataset currently stored at the second physical storage address, and determining that the generation number from the header data structure associated with the dataset currently stored at the second physical storage address does not match the generation number stored in the PD storing the second logical storage address, indicating that the dataset originally or previously stored at the second physical storage address has been changed and moved to a different physical storage address.

In certain arrangements, the method includes, having determined that the generation number from the header data structure associated with the dataset currently stored at the second physical storage address does not match the generation number stored in the PD storing the second logical storage address, obtaining the different physical storage address using a multi-layered storage stack.

In certain arrangements, the method includes, having obtained the different physical storage address using the multi-layered storage stack, reading the dataset stored at the different physical storage address, and returning, to the client, one or more data pages from among the second plurality of data pages included in the second dataset, as specified in the second read request.

In certain embodiments, a system includes a mapping cache, a memory, and processing circuitry configured to execute program instructions out of the memory to receive a read request for reading at least a portion of a dataset including a plurality of data pages. The dataset is associated with a logical storage address. The processing circuitry is configured to execute the program instructions out of the memory, in response to a cache hit in the mapping cache based on a hash of the logical storage address, to obtain, from an in-memory page descriptor (PD) storing the logical storage address, a physical storage address, and a generation number for a dataset originally or previously stored at the physical storage address. The processing circuitry is configured to execute the program instructions out of the memory to obtain a generation number from a header data structure associated with a dataset currently stored at the physical storage address, and determine that the generation number from the header data structure matches the generation number stored in the PD, indicating that the dataset originally or previously stored at the physical storage address corresponds to the dataset currently stored at the physical storage address. The processing circuitry is configured to execute the program instructions out of the memory, having determined that the generation number from the header data structure matches the generation number stored in the PD, to read the dataset currently stored at the physical storage address, and return, to the client, one or more data pages from among the plurality of data pages included in the dataset, as specified in the read request.

In certain arrangements, the processing circuitry is configured to execute the program instructions out of the memory to determine that the dataset is compressed, and decompress the dataset to obtain the plurality of data pages.

In certain arrangements, the processing circuitry is configured to execute the program instructions out of the memory to calculate hash values for the one or more data pages, and determine, in a read validation process, whether the calculated hash values match corresponding hash values in the header data structure.

In certain arrangements, the processing circuitry is configured to execute the program instructions out of the memory to return the one or more data pages to the client in response to the calculated hash values matching the corresponding hash values in the header data structure.

In certain arrangements, the processing circuitry is configured to execute the program instructions out of the memory, in response to the calculated hash values not matching the corresponding hash values in the header data structure, to perform cache miss processing including removing a hash line corresponding to the cache hit from the mapping cache, and return the PD to a pool of PDs to make the PD available for reuse.

In certain arrangements, the processing circuitry is configured to execute the program instructions out of the memory to receive a second read request for reading at least a portion of a second dataset including a second plurality of data pages. The second dataset is associated with a second logical storage address. The processing circuitry is configured to execute the program instructions out of the memory, in response to a cache hit in the mapping cache based on a hash of the second logical storage address, obtain, from an in-memory PD storing the second logical storage address, a second physical storage address, and a generation number for a dataset originally or previously stored at the second physical storage address. The processing circuitry is configured to execute the program instructions out of the memory to obtain a generation number from a header data structure associated with a dataset currently stored at the second physical storage address, and determine that the generation number from the header data structure associated with the dataset currently stored at the second physical storage address does not match the generation number stored in the PD storing the second logical storage address, indicating that the dataset originally or previously stored at the second physical storage address has been changed and logged at a different physical storage address.

In certain arrangements, the processing circuitry is configured to execute the program instructions out of the memory, having determined that the generation number from the header data structure associated with the dataset currently stored at the second physical storage address does not match the generation number stored in the PD storing the second logical storage address, to obtain the different physical storage address using a multi-layered storage stack.

In certain arrangements, the processing circuitry is configured to execute the program instructions out of the memory, having obtained the different physical storage address using the multi-layered storage stack, to read the dataset stored at the different physical storage address, and return, to the client, one or more data pages from among the second plurality of data pages included in the second dataset, as specified in the second read request.

In certain arrangements, the mapping cache includes multiple entries, each entry of the mapping cache having a “key” corresponding to a hash of a logical storage address of a respective dataset, and a value corresponding to an index of a page descriptor (PD) that stores a physical storage address of the respective dataset.

In certain embodiments, a computer program product includes a set of non-transitory, computer-readable media having program instructions that, when executed by processing circuitry, cause the processing circuitry to perform a method including receiving a read request for reading at least a portion of a dataset including a plurality of data pages. The dataset is associated with a logical storage address. The method includes, in response to a cache hit in a mapping cache based on a hash of the logical storage address, obtaining, from an in-memory page descriptor (PD) storing the logical storage address, a physical storage address, and a generation number for a dataset originally or previously stored at the physical storage address. The method includes obtaining a generation number from a header data structure associated with a dataset currently stored at the physical storage address, and determining that the generation number from the header data structure matches the generation number stored in the PD, indicating that the dataset originally or previously stored at the physical storage address corresponds to the dataset currently stored at the physical storage address. The method includes, having determined that the generation number from the header data structure matches the generation number stored in the PD, reading the dataset currently stored at the physical storage address, and returning, to the client, one or more data pages from among the plurality of data pages included in the dataset, as specified in the read request.

Other features, functions, and aspects of the present disclosure will be evident from the Detailed Description that follows.

### BRIEF DESCRIPTION OF THE DRAWINGS

The foregoing and other objects, features, and advantages will be apparent from the following description of particular embodiments of the present disclosure, as illustrated in the accompanying drawings, in which like reference characters refer to the same parts throughout the different views.

FIG. 1 is a block diagram of an exemplary storage environment, in which techniques can be practiced for reducing a memory footprint and improving performance of a mapping cache in a storage system;

FIG. 2a is a diagram of an exemplary namespace layer that can be implemented in the storage system of FIG. 1;

FIG. 2b is a diagram of an exemplary virtualization layer that can be implemented in the storage system of FIG. 1;

FIG. 2c is a diagram of an exemplary physical layer that can be implemented in the storage system of FIG. 1;

FIG. 2d is a diagram of a multi-layered storage stack, including the namespace layer, the virtualization layer, and the physical layer of FIGS. 2a, 2b, and 2c, respectively, and an exemplary mapping layer, which can be implemented in the storage system of FIG. 1, the mapping layer and the virtualization layer providing multiple layers of indirection for accessing stored datasets in the physical layer;

FIG. 3 is a diagram of an exemplary mapping cache that can be implemented in the storage system of FIG. 1;

FIG. 4 illustrates diagrams of an exemplary mapping cache and an exemplary physical large block (PLB) that can be implemented in the storage system of FIG. 1, in which the mapping cache and the PLB are used in descriptions of illustrative examples of operating the storage system of FIG. 1; and

FIG. 5 is a flow diagram of an exemplary method of reducing a memory footprint and improving performance of a mapping cache in a storage system.

### DETAILED DESCRIPTION

Techniques are disclosed herein for reducing memory footprints and improving performance of mapping caches in storage systems. In the disclosed techniques, a storage system can implement a multi-layered storage stack for mapping logical block addresses (LBAs) of storage objects (e.g., volumes) to virtual addresses in virtual large blocks (VLBs), in which the VLB addresses point to physical addresses of datasets (e.g., one or more data pages) in physical large blocks (PLBs). Actual physical storage of the datasets can be provided on one or more underlying storage drives in the backend. The storage system can include at least one mapping cache, which can provide direct mappings of volume LBAs to PLB addresses for recently accessed datasets, effectively bypassing at least the multi-layered storage stack. The storage system can maintain a header data structure (“PLB header”) for each compressed (or uncompressed) dataset, and store the PLB header with the dataset at a PLB address. The PLB header can include a generation number for the dataset stored at the PLB address, and a hash value for each data page included in the dataset. The storage system can also maintain an in-memory PD for the dataset stored at the PLB address. The PD can store a volume LBA and a generation number for the dataset at the PLB address, as well as an indication of the PLB address (e.g., PLB address/offset/length). By employing, in a storage system, a mapping cache that can provide direct mappings of volume LBAs to PLB addresses for recently accessed datasets, an amount of central processing unit (CPU) cycles required for reading datasets in physical storage can be reduced. In addition, by maintaining one or more hash values in PLB headers associated with the datasets in physical storage, memory space and consumption in the storage system can also be reduced.

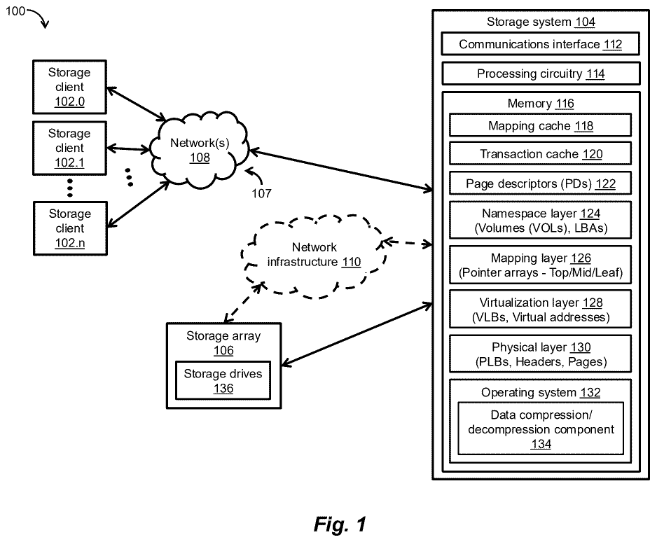

FIG. 1 depicts an illustrative embodiment of an exemplary storage environment 100 for reducing memory footprints and improving performance of mapping caches in storage systems. As shown in FIG. 1, the storage environment 100 can include a plurality of storage client computers (“clients”) 102.0, 102.1, . . . , 102.n, a storage system 104, a storage array 106, and a communications medium 107 that includes at least one network 108. Each client 102.0, . . . , 102.n can provide, over the network(s) 108, storage input/output (IO) requests (e.g., small computer system interface (SCSI) commands, network file system (NFS) commands) to the storage system 104. Such storage IO requests (e.g., write requests, read requests) can direct the storage system 104 to write or read data pages, data blocks, data files, or any other suitable data elements or datasets to/from volumes (VOLs), virtual volumes (VVOLs) (e.g., VMware® VVOLs), logical units (LUs), filesystems, or any other suitable storage objects maintained on storage drives 136 (e.g., solid state drives (SSDs), hard disk drives (HDDs), flash drives) of the storage array 106.

The communications medium 107 can be configured to interconnect the plurality of clients 102.0, . . . , 102.n with the storage system 104, enabling them to communicate and exchange data and control signaling. As shown in FIG. 1, the communications medium 107 can be illustrated as a cloud to represent different network topologies, such as a storage area network (SAN) topology, a network attached storage (NAS) topology, a local area network (LAN) topology, a metropolitan area network (MAN) topology, a wide area network (WAN) topology, and so on. As such, the communications medium 107 can include copper-based communications devices and cabling, fiber optic devices and cabling, wireless devices, and so on, or any suitable combination thereof.

The storage system 104 can be connected directly to the storage array 106, or indirectly through an optional network infrastructure 110, which can include an Ethernet network, an InfiniBand network, a Fibre Channel (FC) network, or any other suitable network. As shown in FIG. 1, the storage system 104 can include a communications interface 112, processing circuitry 114, and a memory 116. The communications interface 112 can include an Ethernet interface, an InfiniBand interface, an FC interface, or any other suitable interface. The communications interface 112 can further include SCSI target adapters, network interface adapters, or any other suitable adapters, for converting electronic, optical, or wireless signals received over the network(s) 108 to a form suitable for use by the processing circuitry 114. The processing circuitry 114 (e.g., central processing unit (CPU)) can include a set of processing cores (e.g., CPU cores) configured to execute specialized software/firmware code, logic, and/or modules as program instructions out of the memory 116, to service storage IO requests (e.g., write requests, read requests) issued by the clients 102.0, . . . , 102.n, and to store data elements or datasets (e.g., one or more data pages) on the storage drives 136 within the storage environment 100, which can be a RAID (Redundant Array of Independent Disks) environment.

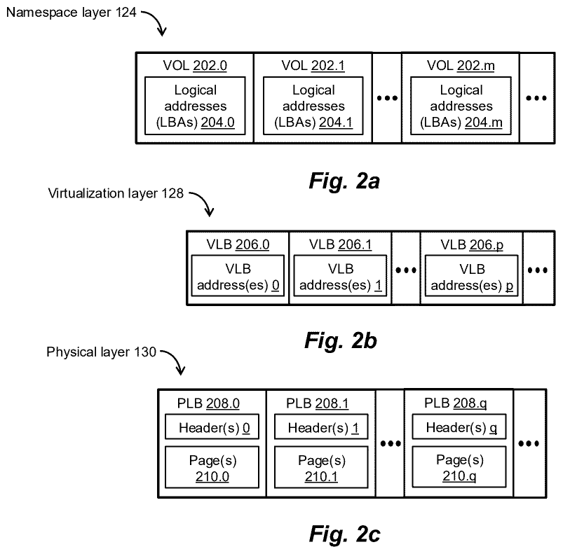

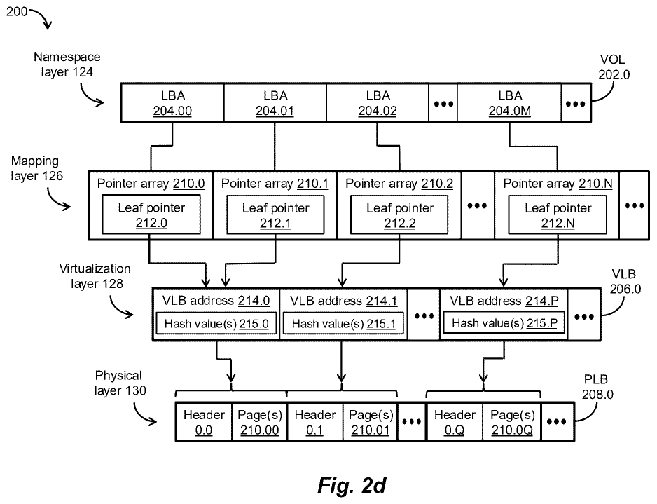

The memory 116 can include volatile memory, such as random access memory (RAM) or any other suitable volatile memory, and nonvolatile memory, such as nonvolatile RAM (NVRAM) or any other suitable nonvolatile memory. As shown in FIG. 1, the memory 116 can include a volatile mapping cache memory (“mapping cache”) 118, and a nonvolatile transaction cache memory (“transaction cache”) 120. The memory 116 can accommodate a variety of specialized software constructs, including a pool of page descriptors (PDs) 122, and a multi-layered storage stack 200 (see FIG. 2d) including a namespace layer 124, a mapping layer 126, a virtualization layer 128, and a physical layer 130. The memory 116 can also accommodate an operating system (OS) 132, such as a Linux OS, Unix OS, Windows OS, or any other suitable OS, as well as a data compression/decompression component 134.

The transaction cache 120 can store or cache data pages to be written, as part of transactions, to at least one of the storage drives 136 for persistent long term storage. Once one or more such data pages specified in a write request have been stored or cached in the transaction cache 120, the storage system 104 can immediately send an acknowledgement of the write request to the client 102.0, . . . , or 102.n that issued it, before persisting the data pages on the storage drives 136. In this way, the transaction cache 120 can store or cache “dirty” versions of data pages, which may be more up to date than corresponding versions stored on the storage drives 136, but not yet “flushed” from the transaction cache 120 to the storage drives 136.

The namespace layer 124 can be configured as a logical structure for organizing storage objects accessible to the plurality of clients 102.0, . . . , 102.n, such as VOLs, VVOLs, LUS, filesystems, or any other suitable storage objects. The namespace layer 124 can track logical addresses (e.g., LBAs) of storage objects (e.g., VOLs). For example, if a VOL has a maximum size of 1 gigabyte (GB), then the namespace layer 124 may provide a 1 GB logical address range to accommodate the VOL. The mapping layer 126 (e.g., “mid” level) can be configured as a logical structure for mapping LBAs of VOLs in the namespace layer 124 (e.g., “top” level) to virtual addresses in the virtualization layer 128. The mapping layer 126 can include a plurality of pointer arrays arranged as multi-level tree data structures (e.g., b-trees), a lowest level (e.g., “leaf” level) of which can include a plurality of leaf pointers.

The virtualization layer 128 can be configured as a logical structure for providing page virtualization in support of data deduplication (“dedupe”). The virtualization layer 128 can include an aggregation of virtual layer blocks (VLBs), each of which can include one or more virtual addresses that point to locations of compressed (or uncompressed) datasets in the physical layer 130. For example, each compressed dataset may correspond to a deep compressed dataset, in which several data pages (e.g., 4 or 8 data pages) are compressed together. The physical layer 130 can be configured as a logical structure for storing an aggregation of physical layer blocks (PLBs), each of which can have a capacity (e.g., 2 megabytes (Mb) total) for storing one or more of the compressed (or uncompressed) datasets. It is noted that, although the physical layer 130 is described herein using the term, “physical,” one or more underlying storage drives (e.g., storage drives 136) are responsible for the actual physical storage of the compressed (or uncompressed) datasets.

FIGS. 2a, 2b, and 2c depict the namespace layer 124, the virtualization layer 128, and the physical layer 130, respectively, of FIG. 1. The namespace layer 124 (see FIG. 2a) can organize a plurality of volumes (VOLs), such as a VOL 202.0, a VOL 202.1, and so on, up to at least a VOL 202.m. The namespace 124 can track logical addresses (LBAs) of the VOLs 202.0, . . . , 202.m, . . . , such as LBAs 204.0 for the VOL 202.0, LBAs 204.1 for the VOL 202.1, and so on, up to at least LBAs 204.m for the VOL 202.m.

The virtualization layer 128 (see FIG. 2b) can include an aggregation of VLBs, such as a VLB 206.0, a VLB 206.1, and so on, up to at least a VLB 206.p. Each VLB 206.0, . . . , 206.p, . . . can include one or more virtual addresses (“VLB addresses”), such as VLB address(es) “0” included in the VLB 206.0, VLB address(es) “1” included in the VLB 206.1, and so on, up to at least VLB address(es) “p” included in the VLB 206.p.

The physical layer 130 can store an aggregation of PLBs, such as a PLB 208.0, a PLB 208.1, and so on, up to at least a PLB 208.q. Each PLB 208.0, . . . , 208.q, . . . can store a compressed (or uncompressed) dataset (e.g., one or more data pages or “pages”), such as page(s) 210.0 stored in the PLB 208.0, page(s) 210.1 stored in the PLB 208.1, and so on, up to at least page(s) 210.q stored in the PLB 208.q. The physical layer 130 can further include header data structures (“PLB headers” or “headers”) stored in association with datasets (e.g., page(s)) at physical addresses of a PLB (“PLB addresses”), such as header(s) “0” for the page(s) 210.0 in PLB 208.0, header(s) “1” for the page(s) 210.1 in PLB 208.1, and so on, up to at least header(s) “q” for the page(s) 210.q in PLB 208.q.

FIG. 2d depicts the multi-layered storage stack 200, including the namespace layer 124, the mapping layer 126, the virtualization layer 128, and the physical layer 130, in which the mapping layer 126 and the virtualization layer 128 are configured to provide multiple layers of indirection for accessing stored datasets in the physical layer 130. As shown in FIG. 2d, the namespace layer 124 includes the VOL 202.0, which can have an LBA 204.00, an LBA 204.01, an LBA 204.02, . . . , and so on, up to at least an LBA 204.0M, associated therewith. For example, the LBAs 204.00, . . . , 204.0M, . . . may correspond to contiguous offsets into the VOL 202.0. The virtualization layer 128 includes the VLB 206.0, which can include a VLB address 214.0, a VLB address 214.1, and so on, up to at least a VLB address 214.P. The mapping layer 126 can include a pointer array 210.0, a pointer array 210.1, a pointer array 210.2, and so on, up to at least a pointer array 210.N. The pointer array 210.0 can include a leaf pointer 212.0, the pointer array 210.1 can include a leaf pointer 212.1, the pointer array 210.2 can include a leaf pointer 212.2, and so on, up to at least the pointer array 210.N, which can include a leaf pointer 212.N. The mapping layer 126 (see FIG. 2 d) can map the LBAs 204.00, . . . , 204.0M, . . . of the VOL 202.0 to the VLB addresses 214.0, . . . , 214.P, For example, the leaf pointer 212.0 may map the LBA 204.00 to the VLB address 214.0, the leaf pointer 212.1 may also map the LBA 204.01 to the VLB address 214.0 (e.g., as a result of dedupe), the leaf pointer 212.2 may map the LBA 204.02 to the VLB address 214.1, and so on, up to at least the leaf pointer 212.N, which may map the LBA 204.0M to the VLB address 214.P.

The physical layer 130 includes the PLB 208.0, which can include page(s) 210.00 and an associated header 0.0, page(s) 210.01 and an associated header 0.1, and so on, up to at least page(s) 210.0Q and an associated header 0.Q. For example, the VLB address 214.0 may point to a PLB address of the page(s) 210.00 and its associated header 0.0, the VLB address 214.1 may point to a PLB address of the page(s) 210.01 and its associated header 0.1, and so on, up to at least the VLB address 214.P, which may point to a PLB address of the page(s) 210.0Q and its associated header 0.Q. It is noted that hash value(s) 215.0 can be calculated for each of the page(s) 210.00 for read validation purposes, and stored in the VLB 206.0 in association with the VLB address 214.0. Likewise, hash value(s) 215.1 can be calculated for each of the page(s) 210.01 for read validation purposes, and stored in the VLB 206.0 in association with the VLB address 214.1, and so on, up to at least hash value(s) 215.P, which can be calculated for each of the page(s) 210.0Q for read validation purposes, and stored in the VLB 206.0 in association with the VLB address 214.P. For example, a 20 bit hash value may be calculated for each 4Kb page.

In the disclosed techniques, the storage system 104 can include and use at least one mapping cache 118 (see FIG. 1), which can be configured to provide direct mappings of volume LBAs to PLB addresses for recently accessed datasets (e.g., one or more data pages), effectively bypassing both the transaction cache 120 (see FIG. 1) and the multi-layered storage stack 200 (see FIG. 2d). The storage system 104 can maintain a PLB header with each compressed (or uncompressed) dataset stored at a PLB address. The PLB header can include at least (i) a generation number for the dataset at the PLB address, and (ii) a hash value, for read validation purposes, for each data page included in the dataset. It is noted that hash values included in the PLB headers can correspond to the same hash values (e.g., hash values 215.0, 215.1, . . . , 215.P; see FIG. 2d) calculated in a normal IO flow through the multi-layered storage stack 200, and therefore need not be recalculated.

The storage system can further include and use an in-memory pool of page descriptors (PDs) 122 (see FIG. 1) for compressed (or uncompressed) datasets stored at respective PLB addresses. Each PD can store at least (i) a volume LBA associated with a dataset, (ii) a generation number for the dataset at a respective PLB address, and (iii) an indication of the respective PLB address (e.g., PLB address/offset/length). As employed herein, the term, “generation number,” refers to a monotonically increasing number or value associated with a compressed (or uncompressed) dataset stored at a specified PLB address, in which the generation number can be incremented each time data at the specified PLB address is changed, modified, or replaced, or when an original dataset at the specified PLB address is moved, stored, or logged at a different PLB address. For example, the generation number may be incremented when servicing a write request for writing a new dataset at the specified PLB address, or when the original dataset at the specified PLB address is moved to a different PLB address as part of a garbage collection process, late dedupe process, or late compression process. It is noted that the disclosed techniques are particularly suited for use in storage systems that implement log-structured data storage.

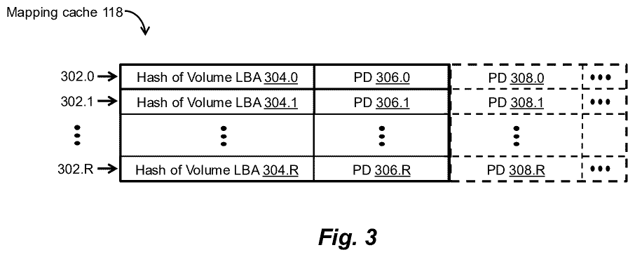

FIG. 3 depicts an exemplary embodiment of the mapping cache 118, which can be implemented in the storage system 104 of FIG. 1. As shown in FIG. 3, the mapping cache 118 can include multiple entries (“hash lines”) 302.0, 302.1, . . . , 302.R, in which each hash line 302.0, . . . , 302.R has a corresponding “key,” namely, a hash of a volume LBA of a dataset, and “value,” namely, an index of a PD that stores a PLB address of the dataset. For example, the hash line 302.0 may have a corresponding key, namely, a hash of volume LBA 304.0, and value, namely, an index of a PD 306.0; the hash line 302.1 may have a corresponding key, namely, a hash of volume LBA 304.1, and value, namely, an index of a PD 306.1; and so on, up to the hash line 302.R, which may have a corresponding key, namely, a hash of volume LBA 304.R, and value, namely, an index of a PD 306.R. Further, each hash line 302.0, . . . , 302.R of the mapping cache 118 may be accessed based on a hash of a volume LBA of a dataset using any suitable cryptographic hash function (e.g., SHA-1, SHA-2). Accordingly, the hash line 302.0 can be accessed by obtaining a hash of the volume LBA 304.0, the hash line 302.1 can be accessed by obtaining a hash of the volume LBA 304.1, and so on, up to the hash line 302.R, which can be accessed by obtaining a hash of the volume LBA 304.R.

Because the storage system 104 can be configured to store exabytes of data (e.g., 30 to 40 terabytes or more), obtaining hash values of volume LBAs of such a large amount of data can potentially lead to hash collisions, resulting in multiple volume LBAs of datasets being hashed into the same hash line 302.0, 302.1, . . . , or 302.R of the mapping cache 118. In other words, hashes of multiple volume LBAs can potentially produce the same hash value. To account for such hash collisions, each hash line 302.0, . . . , 302.R can have a value that includes indexes for a singly linked list of PDs, in which each PD stores at least (i) a volume LBA associated with a respective dataset, (ii) a generation number for a compressed (or uncompressed) dataset at a PLB address, and (iii) an indication of the PLB address (e.g., PLB address/offset/length). For example, the hash line 302.0 may have a value that includes indexes for a singly linked list consisting of at least the PD 306.0 and a PD 308.0, the hash line 302.1 may have a value that includes indexes for a singly linked list consisting of at least the PD 306.1 and a PD 308.1, and so on, up to the hash line 302.R, which may have a value that includes indexes for a singly linked list consisting of at least the PD 306.R and a PD 308.R. Having accessed a hash line that has a value including indexes for a singly linked list of PDs, the storage system 104 can walk through the PDs in the singly linked list, and determine an appropriate PD to use based on the volume LBAs stored in the PDs.

During operation, the storage system 104 can receive a read request for reading at least a portion of a dataset including a plurality of data pages, in which the dataset is associated with a volume LBA. In response to a mapping cache hit based on a hash of the volume LBA, the storage system 104 can obtain, from a PD storing the volume LBA, a PLB address, and a first generation number for a compressed (or uncompressed) dataset originally (or previously) stored at the PLB address. The storage system 104 can obtain a second generation number from a PLB header associated with a dataset currently stored at the PLB address. The storage system 104 can determine that the second generation number matches the first generation number, indicating that the dataset originally (or previously) stored at the PLB address corresponds to the dataset currently stored at the PLB address, and has not been changed, modified, or replaced, and moved, stored, or logged at a different PLB address.

Having determined that the second generation number matches the first generation number, the storage system 104 can (i) read the dataset currently stored at the PLB address, (ii) if the dataset is compressed, decompress the dataset to obtain the plurality of data pages, (iii) calculate hash values for one or more data pages from among the plurality of data pages, as specified in the read request, (iv) determine that the hash values for the one or more data pages match corresponding hash values in the PLB header, and (v) in response to the hash values for the one or more data pages matching the corresponding hash values in the PLB header, return the one or more data pages to the client. By employing, in a storage system, a mapping cache that can provide direct mappings of volume LBAs to PLB addresses for recently accessed datasets, an amount of CPU cycles required for reading datasets in physical storage can be reduced. In addition, by maintaining one or more hash values in PLB headers associated with the datasets in physical storage, memory space and consumption in the storage system can also be reduced.

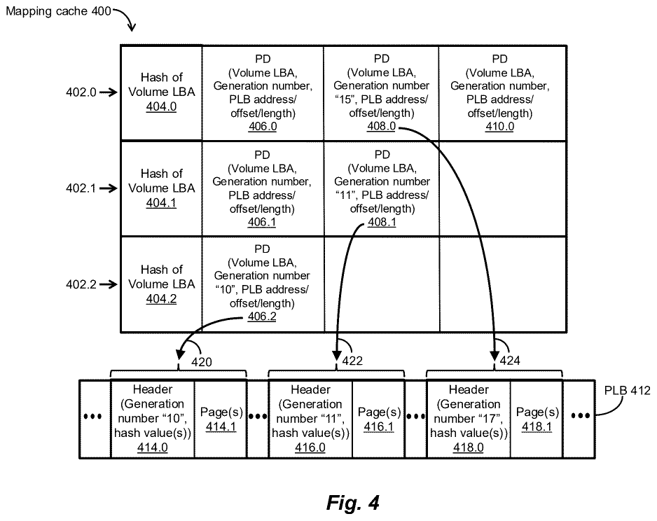

The disclosed techniques for reducing memory footprints and improving performance of mapping caches in storage systems will be further understood with reference to the following illustrative examples and FIGS. 1, 2, and 4. In these examples, it is assumed that the storage system 104 (see FIG. 1) is configured to implement log-structured data storage. It is further assumed that the storage system 104 includes and uses an exemplary mapping cache 400 (see FIG. 4) with at least hash lines 402.0, 402.1, 402.2, in which the hash line 402.0 has, as a key, a hash of volume LBA 404.0, and, as a value, indexes for a singly linked list of three (3) PDs 406.0, 408.0, 410.0; the hash line 402.1 has, as a key, a hash of volume LBA 404.1, and, as a value, indexes for a singly linked list of two (2) PDs 406.1, 408.1; and the hash line 402.2 has, as a key, a hash of volume LBA 404.2, and, as a value, an index of a single PD 406.2.

In a first example, the storage system 104 receives a first read request for reading at least a portion of a compressed dataset associated with a specified volume LBA. The storage system 104 obtains a hash of the specified volume LBA, resulting in a mapping cache hit, as indicated by the hash of the specified volume LBA being equal to the hash of volume LBA 404.2. In other words, the volume LBA specified in the first read request is hashed into the hash line 402.2 of the mapping cache 400. In response to the mapping cache hit, the storage system 104 accesses the PD 406.2, which stores at least a volume LBA, a physical address (“PLB address”) (e.g., PLB address/offset/length) of a compressed dataset (e.g., page(s) 414.1; see FIG. 4) stored in a PLB 412, and a generation number (“10”) for the page(s) 414.1 at the PLB address. As indicated by a reference arrow 420, the PLB address stored in the PD 406.2 corresponds to a PLB address in the PLB 412, which stores, at the PLB address, the page(s) 414.1, and a PLB header (“header”) 414.0 for the page(s) 414.1. The storage system 104 accesses the header 414.0, which includes a generation number (“10”) for the page(s) 414.1 at the PLB address, and determines that the generation number (“10”) stored in the PD 406.2 matches the generation number (“10”) included in the header 414.0, indicating that data in the compressed dataset (e.g., page(s) 414.1) has not been changed, modified, or replaced, and moved, stored, or logged at a different PLB address.

It is noted that, if it were determined that the generation number stored in the PD 406.2 does not match the generation number included in the header 414.0, indicating that the data in the compressed dataset (e.g., page(s) 414.1) has been changed, modified, or replaced, and moved, stored, or logged at a different PLB address, then the storage system 104 would remove the hash line 402.2 corresponding to the cache hit from the mapping cache 400, return the PD 406.2 to the pool of PDs 122 to make it available for reuse, and use the multi-layered storage stack 200 to obtain the different PLB address, updating the mapping cache 400 accordingly. For example, the direct mapping of the volume LBA to the different PLB address of the compressed dataset, obtained using the multi-layered storage stack 200, may be promoted as an entry in the mapping cache 400.

In response to determining that the generation number (“10”) stored in the PD 406.2 matches the generation number (“10”) included in the header 414.0, the storage system 104 reads the compressed dataset (e.g., page(s) 414.1) at the PLB address, decompresses the dataset to obtain the respective page(s) 414.1, and calculates hash value(s) for one or more pages from among the respective page(s) 414.1, as specified in the first read request. The storage system 104 determines, in a read validation process, whether the calculated hash value(s) match corresponding hash value(s) maintained in the header 414.0, and, upon a successful read validation, returns the one or more pages to the client. If the read validation were unsuccessful, then the storage system 104 would proceed along a normal cache miss path, remove the hash line 402.2 from the mapping cache 400, and return the PD 406.2 to the pool of PDs 122.

In a second example, the storage system 104 receives a second read request for reading at least a portion of a compressed dataset associated with a specified volume LBA. The storage system 104 obtains a hash of the specified volume LBA, resulting in a mapping cache hit, as indicated by the hash of the specified volume LBA being equal to the hash of volume LBA 404.1. In other words, the volume LBA specified in the second read request is hashed into the hash line 402.1 of the mapping cache 400. In response to the mapping cache hit, the storage system 104 walks through the singly linked list of two (2) PDs 406.1, 408.1, and determines an appropriate one of the PDs 406.1, 408.1 to use, based on a volume LBA stored in the PD 406.1 or 408.1 corresponding to the volume LBA specified in the second read request. In this second example, the storage system 104 determines that the PD 408.1 is the appropriate one to use. The storage system 104 accesses the PD 408.1, which stores, along with the volume LBA, at least a physical address (“PLB address”) (e.g., PLB address/offset/length) of a compressed dataset (e.g., page(s) 416.1; see FIG. 4) stored in the PLB 412, and a generation number (“11”) for the page(s) 416.1 at the PLB address. As indicated by a reference arrow 422, the PLB address stored in the PD 408.1 corresponds to a PLB address in the PLB 412, which stores, at the PLB address, the page(s) 416.1, and a PLB header (“header”) 416.0 for the page(s) 416.1. The storage system 104 accesses the header 416.0, which includes a generation number (“11”) for the page(s) 416.1 at the PLB address, and determines that the generation number (“11”) stored in the PD 408.1 matches the generation number (“11”) included in the header 416.0, indicating that data in the compressed dataset (e.g., page(s) 416.1) has not been changed, modified, or replaced, and moved, stored, or logged at a different PLB address.

It is noted that, if it were determined that the generation number stored in the PD 408.1 does not match the generation number included in the header 416.0, indicating that the data in the compressed dataset (e.g., page(s) 416.1) has been changed, modified, or replaced, and moved, stored, or logged at a different PLB address, then the storage system 104 would remove the hash line 402.1 corresponding to the cache hit from the mapping cache 400, return the PDs 406.1, 408.1 to the pool of PDs 122 to make them available for reuse, and use the multi-layered storage stack 200 to obtain the PLB address of the compressed dataset, updating the mapping cache 400 accordingly. For example, the direct mapping of the volume LBA to the PLB address for the compressed dataset, obtained using the multi-layered storage stack 200, may be promoted as an entry in the mapping cache 400.

In response to determining that the generation number (“11”) stored in the PD 408.1 matches the generation number (“11”) included in the header 416.0, the storage system 104 reads the compressed dataset (e.g., page(s) 416.1) at the PLB address, decompresses the dataset to obtain the respective page(s) 416.1, and calculates hash value(s) for one or more pages from among the respective page(s) 416.1, as specified in the second read request. The storage system 104 determines, in a read validation process, whether the calculated hash value(s) match corresponding hash value(s) maintained in the header 416.0, and, upon a successful read validation, returns the one or more pages to the client. If the read validation were unsuccessful, then the storage system 104 would proceed along the normal cache miss path, remove the hash line 402.1 from the mapping cache 400, and return the PDs 406.1, 408.1 to the pool of PDs 122.

In a third example, the storage system 104 receives a third read request for reading at least a portion of a compressed dataset associated with a specified volume LBA. The storage system 104 obtains a hash of the specified volume LBA, resulting in a mapping cache hit, as indicated by the hash of the specified volume LBA being equal to the hash of volume LBA 402.0. In other words, the volume LBA specified in the third read request is hashed into the hash line 402.0 of the mapping cache 400. In response to the mapping cache hit, the storage system 104 walks through the singly linked list of three (3) PDs 406.0, 408.0, 410.0, and determines an appropriate one of the PDs 406.0, 408.0, 410.0 to use, based on a volume LBA stored in the PD 406.0, 408.0, or 410.0 corresponding to the volume LBA specified in the third read request. In this third example, the storage system 104 determines that the PD 408.0 is the appropriate one to use. The storage system 104 accesses the PD 408.0, which stores, along with the volume LBA, at least a physical address (“PLB address”) (e.g., PLB address/offset/length) of a compressed dataset stored in the PLB 412, and a generation number (“15”) for the compressed dataset at the PLB address. As indicated by a reference arrow 424, the PLB address stored in the PD 408.0 corresponds to a PLB address in the PLB 412, which stores, at the PLB address, page(s) 418.1, and a PLB header (“header”) 418.0 for the page(s) 418.1. The storage system 104 accesses the header 418.0, which includes a generation number ((“17”) for the page(s) 418.1 at the PLB address, and determines that the generation number (“15”) stored in the PD 408.0 does not match the generation number ((“17”) included in the header 418.0, indicating that data in the compressed dataset has been changed, modified, or replaced, and moved, stored, or logged at a different PLB address. The storage system 104 therefore removes the hash line 402.0 corresponding to the cache hit from the mapping cache 400, returns the PDs 406.0, 408.0, 410.0 to the pool of PDs 122 to make them available for reuse, and uses the multi-layered storage stack 200 to obtain the different PLB address of the compressed dataset, updating the mapping cache 400 accordingly. For example, the direct mapping of the volume LBA to the different PLB address for the compressed dataset, obtained using the multi-layered storage stack 200, may be promoted as an entry in the mapping cache 400.

Having obtained the different PLB address of the compressed dataset using the multi-layered storage stack 200, the storage system 104 reads the compressed dataset at the different PLB address, decompresses the dataset to obtain respective page(s), and calculates hash value(s) for one or more pages from among the respective page(s), as specified in the third read request. The storage system 104 determines, in a read validation process, whether the calculated hash value(s) match corresponding hash value(s) maintained in a header at the different PLB address, and, upon a successful read validation, returns the one or more pages to the client. If the read validation were unsuccessful, then the storage system 104 would proceed along the normal cache miss path.

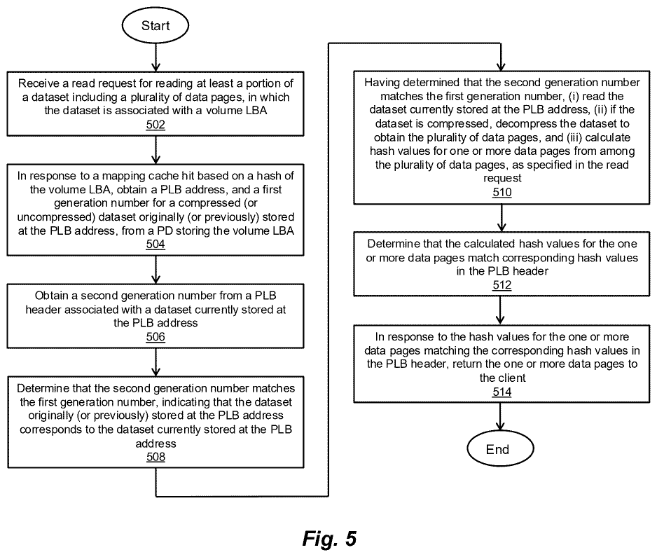

An exemplary method of reducing a memory footprint and improving performance of a mapping cache in a storage system is described below with reference to FIG. 5. As depicted in block 502, a read request is received for reading at least a portion of a dataset including a plurality of data pages, in which the dataset is associated with a volume LBA. As depicted in block 504, in response to a mapping cache hit based on a hash of the volume LBA, a PLB address, and a first generation number for a compressed (or uncompressed) dataset originally (or previously) stored at the PLB address, are obtained from a PD storing the volume LBA. As depicted in block 506, a second generation number is obtained from a PLB header associated with a dataset currently stored at the PLB address. As depicted in block 508, the second generation number is determined to match the first generation number, indicating that the dataset originally (or previously) stored at the PLB address corresponds to the dataset currently stored at the PLB address, and has not been changed, modified, or replaced, and moved, stored, or logged at a different PLB address. As depicted in block 510, having determined that the second generation number matches the first generation number, (i) the dataset currently stored at the PLB address is read, (ii) if the dataset is compressed, the dataset is decompressed to obtain the plurality of data pages, and (iii) hash values for one or more data pages from among the plurality of data pages, as specified in the read request, are calculated. As depicted in block 512, the calculated hash values for the one or more data pages are determined to match corresponding hash values in the PLB header. As depicted in block 514, in response to the hash values for the one or more data pages matching the corresponding hash values in the PLB header, the one or more data pages are returned to the client.

Having described the above illustrative embodiments, various alternative embodiments and/or variations may be made and/or practiced. For example, it was described herein that, when data in a dataset at an initial PLB address has been changed, modified, or replaced, and moved, stored, or logged at a different PLB address, a direct mapping of a volume LBA associated with the dataset to the different PLB address may be promoted as an entry in the mapping cache. In the above illustrative and other embodiments, direct mappings of volume LBAs to PLB addresses may also be promoted as entries in the mapping cache when data is written to underlying storage drives in the backend (e.g., at flush time), and/or when data is read from the underlying storage drives in the backend.

It was further described herein that a generation number for a dataset stored at an initial PLB address may be incremented when the dataset is moved to a different PLB address as part of a garbage collection process, freeing up storage space at the initial PLB address for other data.

In the above illustrative and other embodiments, once storage space at a PLB address has been freed up in the garbage collection process, a generation number corresponding to the PLB address can be reset to zero (“0”), and subsequently incremented in response to data being written to (or read from) the PLB address, data at the PLB address being changed, modified, or replaced, and/or data at the PLB address being moved, stored, or logged at a different PLB address.

Several definitions of terms are provided below for the purpose of aiding the understanding of the foregoing description, as well as the claims set forth herein.

As employed herein, the term, “storage system,” is intended to be broadly construed to encompass, for example, private or public cloud computing systems for storing data, as well as systems for storing data comprising virtual infrastructure and those not comprising virtual infrastructure.

As employed herein, the terms, “client,” “host,” and “user,” refer, interchangeably, to any person, system, or other entity that uses a storage system to read/write data.

As employed herein, the term, “storage device,” may refer to a storage array including multiple storage devices. Such a storage device may refer to any non-volatile memory (NVM) device, including hard disk drives (HDDs), solid state drives (SSDs), flash devices (e.g., NAND flash devices, NOR flash devices), and/or similar devices that may be accessed locally and/or remotely, such as via a storage area network (SAN).

As employed herein, the term, “storage array,” may refer to a storage system used for block-based, file-based, or other object-based storage. Such a storage array may include, for example, dedicated storage hardware containing HDDs, SSDs, and/or all-flash drives.

As employed herein, the term, “storage entity,” may refer to a filesystem, an object storage, a virtualized device, a logical unit (LUN), a logical volume (LV), a logical device, a physical device, and/or a storage medium.

As employed herein, the term, “LUN” or “LU,” may refer to a logical entity provided by a storage system for accessing data from the storage system and may be used interchangeably with a logical volume (LV). The term, “LUN,” may also refer to a logical unit number for identifying a logical unit (LU), a virtual disk, or a virtual LUN.

As employed herein, the term, “physical storage unit,” may refer to a physical entity such as a storage drive or disk or an array of storage drives or disks for storing data in storage locations accessible at addresses. The term, “physical storage unit,” may be used interchangeably with the term, “physical volume.”

As employed herein, the term, “storage medium,” may refer to a hard drive or flash storage, a combination of hard drives and flash storage, a combination of hard drives, flash storage, and other storage drives or devices, or any other suitable types and/or combinations of computer readable storage media. Such a storage medium may include physical and logical storage media, multiple levels of virtual-to-physical mappings, and/or disk images. The term, “storage medium,” may also refer to a computer-readable program medium.

As employed herein, the term, “IO request” or “IO,” may refer to a data input or output request such as a read request or a write request.

As employed herein, the terms, “such as,” “for example,” “e.g.,” “exemplary,” and variants thereof, refer to non-limiting embodiments and have meanings of serving as examples, instances, or illustrations. Any embodiments described herein using such phrases and/or variants are not necessarily to be construed as preferred or more advantageous over other embodiments, and/or to exclude incorporation of features from other embodiments.

As employed herein, the term, “optionally,” has a meaning that a feature, element, process, etc., may be provided in certain embodiments and may not be provided in certain other embodiments. Any particular embodiment of the present disclosure may include a plurality of optional features unless such features conflict with one another.

While various embodiments of the present disclosure have been particularly shown and described, it will be understood by those skilled in the art that various changes in form and details may be made therein without departing from the scope of the present disclosure, as defined by the appended claims.

1. A method comprising:
receiving a data read request from a client, the data read request specifying one or more data pages from among a plurality of data pages, and a logical storage address;
in response to a cache hit in a mapping cache based on a hash of the logical storage address, obtaining, from an in-memory page descriptor (PD) storing the logical storage address, a physical storage address, and a first generation number for an originally or previously stored version of a dataset at the physical storage address;
obtaining a second generation number from a header data structure associated with a currently stored version of the dataset at the physical storage address;
determining that the second generation number from the header data structure matches the first generation number stored in the in-memory PD, indicating that the originally or previously stored version of the dataset at the physical storage address corresponds to the currently stored version of the dataset at the physical storage address;
having determined that the second generation number from the header data structure matches the first generation number stored in the in-memory PD, reading the dataset currently stored version of the dataset at the physical storage address; and
returning, to the client, the one or more data pages from among the plurality of data pages included in the currently stored version of the dataset at the physical storage address, as specified in the data read request.

2. The method of claim 1 comprising:
determining that the currently stored version of the dataset is compressed; and
decompressing the currently stored version of the dataset to obtain the plurality of data pages.

3. The method of claim 2 comprising:
calculating hash values for the one or more data pages; and
determining, in a read validation process, whether the calculated hash values match corresponding hash values in the header data structure.

4. The method of claim 3 wherein the returning of the one or more data pages to the client includes returning the one or more data pages to the client in response to the calculated hash values matching the corresponding hash values in the header data structure.

5. The method of claim 4 comprising:
in response to the calculated hash values not matching the corresponding hash values in the header data structure:
performing cache miss processing including removing a hash line corresponding to the cache hit from the mapping cache; and
returning the in-memory PD to a pool of PDs to make the in-memory PD available for reuse.

6. The method of claim 1 comprising:
receiving a second data read request from the client, the second data read request specifying one or more second ta pages from among a second plurality of data pages, and a second logical storage address;
in response to a second cache hit in the mapping cache based on a second hash of the second logical storage address, obtaining, from the in-memory PD storing the second logical storage address, a second physical storage address, and a third generation number for an originally or previously stored version of a second dataset at the second physical storage address;
obtaining a fourth generation number from a second header data structure associated with a currently stored version of the second dataset at the second physical storage address; and
determining that the fourth generation number from the second header data structure associated with the currently stored version of the second dataset at the second physical storage address does not match the third generation number stored in the in-memory PD storing the second logical storage address, indicating that the originally or previously stored version of the second dataset at the second physical storage address has been changed and moved to a different physical storage address.

7. The method of claim 6 comprising:
having determined that the fourth generation number from the second header data structure associated with the currently stored version of the second dataset at the second physical storage address does not match the third generation number stored in the in-memory PD storing the second logical storage address, obtaining the different physical storage address using a multi-layered storage stack.

8. The method of claim 7 comprising:
having obtained the different physical storage address using the multi-layered storage stack, reading the originally or previously stored version of the second dataset moved to the different physical storage address, and returning, to the client, the one or more second data pages from among the second plurality of data pages included in the originally or previously stored version of the second dataset, as specified in the second read request.

9. A system comprising:
a mapping cache;
a memory; and
processing circuitry configured to execute program instructions out of the memory to:
receive a data read request from a client, the data read request specifying one or more data pages from among a plurality of data pages, and a logical storage address;
in response to a cache hit in the mapping cache based on a hash of the logical storage address, obtain, from an in-memory page descriptor (PD) storing the logical storage address, a physical storage address, and a first generation number for an originally or previously stored version of a dataset at the physical storage address;
obtain a second generation number from a header data structure associated with a currently stored version of the dataset at the physical storage address;
determine that the second generation number from the header data structure matches the first generation number stored in the in-memory PD, indicating that the originally or previously stored version of the dataset at the physical storage address corresponds to the currently stored version of the dataset at the physical storage address;
having determined that the second generation number from the header data structure matches the first generation number stored in the in memory PD, read the currently stored version of the dataset at the physical storage address; and
return, to the client, the one or more data pages from among the plurality of data pages included in the currently stored version of the dataset at the physical storage address, as specified in the data read request.

10. The system of claim 9 wherein the processing circuitry is configured to execute the program instructions out of the memory to:
determine that the currently stored version of the dataset is compressed; and
decompress the currently stored version of the dataset to obtain the plurality of data pages.

11. The system of claim 10 wherein the processing circuitry is configured to execute the program instructions out of the memory to:
calculate hash values for the one or more data pages; and
determine, in a read validation process, whether the calculated hash values match corresponding hash values in the header data structure.

12. The system of claim 11 wherein the processing circuitry is configured to execute the program instructions out of the memory to return the one or more data pages to the client in response to the calculated hash values matching the corresponding hash values in the header data structure.

13. The system of claim 12 wherein the processing circuitry is configured to execute the program instructions out of the memory, in response to the calculated hash values not matching the corresponding hash values in the header data structure, to:
perform cache miss processing including removing a hash line corresponding to the cache hit from the mapping cache; and
return the in-memory PD to a pool of PDs to make the in-memory PD available for reuse.

14. The system of claim 9 wherein the processing circuitry is configured to execute the program instructions out of the memory to:
receive a second data read request from the client, the second data read request specifying one or more second data pages from among a second plurality of data pages, and a second logical storage address;
in response to a second cache hit in the mapping cache based on a second hash of the second logical storage address, obtain, from the in-memory PD storing the second logical storage address, a second physical storage address, and a third generation number for an originally or previously stored version of a second dataset at the second physical storage address;
obtain a fourth generation number from a second header data structure associated with a currently stored version of the second dataset at the second physical storage address; and
determine that the fourth generation number from the second header data structure associated with the currently stored version of the second dataset at the second physical storage address does not match the third generation number stored in the in-memory PD storing the second logical storage address, indicating that the originally or previously stored version of the second dataset at the second physical storage address has been changed and logged at a different physical storage address.

15. The system of claim 14 wherein the processing circuitry is configured to execute the program instructions out of the memory, having determined that the fourth generation number from the second header data structure associated with the currently stored version of the second dataset at the second physical storage address does not match the third generation number stored in the in-memory PD storing the second logical storage address, to obtain the different physical storage address using a multi-layered storage stack.

16. The system of claim 15 wherein the processing circuitry is configured to execute the program instructions out of the memory, having obtained the different physical storage address using the multi-layered storage stack, to read the originally or previously stored version of the second dataset moved to the different physical storage address, and return, to the client, the one or more second data pages from among the second plurality of data pages included in the originally or previously stored version of the second dataset, as specified in the second read request.

17. The system of claim 9 wherein the mapping cache includes multiple entries, each entry of the mapping cache having a “key” corresponding to a hash of a logical storage address of a respective dataset, and a value corresponding to an index of a page descriptor (PD) that stores a physical storage address of the respective dataset.

18. A computer program product including a set of non-transitory, computer-readable media having program instructions that, when executed by processing circuitry, cause the processing circuitry to perform a method comprising:
receiving a data read request from a client, the data read request specifying one or more data pages from among a plurality of data pages, and a logical storage address;
in response to a cache hit in a mapping cache based on a hash of the logical storage address, obtaining, from an in-memory page descriptor (PD) storing the logical storage address, a physical storage address, and a first generation number for an originally or previously stored version of a dataset at the physical storage address;
obtaining a second generation number from a header data structure associated with a currently stored version of the dataset at the physical storage address;
determining that the second generation number from the header data structure matches the first generation number stored in the in-memory PD, indicating that the originally or previously stored version of the dataset at the physical storage address corresponds to the currently stored version of the dataset at the physical storage address;
having determined that the second generation number from the header data structure matches the first generation number stored in the in-memory PD, reading the currently stored version of the dataset at the physical storage address; and
returning, to the client, the one or more data pages from among the plurality of data pages included in the currently stored version of the dataset at the physical storage address, as specified in the data read request.

19. The computer program product of claim 18 wherein the method comprises:
determining that the currently stored version of the dataset is compressed; and
decompressing the currently stored version of the dataset to obtain the plurality of data pages.

20. The computer program product of claim 19 wherein the method comprises:
calculating hash values for the one or more data pages; and
determining, in a read validation process, that the calculated hash values match corresponding hash values in the header data structure,
wherein the returning of the one or more data pages to the client includes returning the one or more data pages to the client in response to the calculated hash values matching the corresponding hash values in the header data structure.
